(19) United States
(12) Patent Application Publication
(10) Pub. No.: US 2009/0234767 A1
(43) Pub. Date: Sep. 17, 2009

(54) Cost-based financial product

(76) Inventors: J. Peter Steidlmayer, Wilmette, IL (US); Keith D. Bronstein, Chicago, IL (US); Burt Gutterman, Glencoe, IL (US); Leslie Rosenthal, Chicago, IL (US)

Correspondence Address: Paul E Schaafsma, NovusIP, LLC, Suite 221, 521 West Superior Street, Chicago, IL, 60610, US

(21) Appl. No.: 12/075,548

(22) Filed: Mar. 12, 2008

(51) Int. Cl. G06Q 30/00; G06Q 40/00

(52) U.S. Cl. 705/37; 705/35

(57) ABSTRACT

In accordance with the principles of the present invention, a cost-based financial product is provided. The cost-based financial product is created at a front end that differentiates at the access level, thereby providing two distinct products—one evolving from direct arbitrage; the other an indigenous copy—that are essentially the same that can flow separately into different service entities. A fixed yield or amount of supply of a first component is divided into a variable yield of a second component that represents the cost basis relationship sought, thereby creating a partial supply devisor quotient scale—a new scale of cost unit change that becomes the new price array on the front end. A front-end application ladder can be created by substituting a price per divisor supply (whether shares of stock, bushels of grain, etc.) quotient scale for the matrix price array of the cost component to accept the expanding or contracting value of the gross changes of the cost product value. Each trade price increment allowing buying or selling of those differentials as they occur in the mimicked cost product ladder or the indigenous one. The cost-based financial product of the present invention enables an indigenous marketplace where traders can make a directly offsetting trade at any of the trade prices, thereby bypassing the arbitrage base by choosing to use the indigenous one.

### FIELD OF THE INVENTION

The present invention relates to financial products.

### BACKGROUND OF THE INVENTION

Varieties of different types of contracts are traded on various exchanges and other markets throughout the world. A cash contract is a sales agreement for either immediate or deferred delivery of the actual equity or commodity. An option is a contract that conveys the right, but not the obligation, to buy or sell a particular equity, commodity or futures contract on an equity or commodity at a certain price for a limited time. A call option is an option that gives the buyer the right, but not the obligation, to purchase the underlying equity, commodity or futures contract at a certain price (known as the strike price) on or before the expiration date. A put option is an option that gives the option buyer the right, but not the obligation, to sell the underlying equity, commodity or futures contract at the strike price on or before the expiration date.

A futures contract is a legally binding agreement, typically entered into on or pursuant to the rules of an exchange, to buy or sell an asset (such as an equity or a commodity) sometime in the future. A commodity (which may be a financial instrument) is generally an article of commerce or a product that can be used for commerce. An equity is generally an ownership interest in an asset such as stock in a company. In a narrow sense not intended for use herein, futures, options, and stocks are contracts for products normally traded on formally organized exchanges.

The types of commodities commonly include agricultural products such as corn, soybeans, and wheat; precious metals such as gold; fuels such as petroleum; foreign currencies such as the Euro; financial instruments such as U.S. Treasury securities; and financial indexes such as the Standard & Poor's® 500 stock index, to name a few. Standard & Poor's® 500 stock index is disseminated by Standard & Poor's, 55 Water Street, New York, N.Y. 10041. Unlike cash commercial contracts, futures contracts very rarely result in delivery, because most are liquidated by offsetting positions prior to expiration. Even stock trading has shifted from physical delivery to one of electronic recording.

Exchange-traded stocks, commodities, bonds, indices, etc. are traded with a single all-inclusive price as the basis for exchange. For example, futures contracts are standardized according to the quality, quantity, duration, delivery time, and delivery location for each commodity. The quality, quantity, duration, delivery time, and delivery location for each contract are fixed so that the price becomes the single variable. That price itself is made up of untold number of costs—some are excluded, some are soft, some are fixed, and some are variable. Costs, when out of line to any relationship, are imbalances within that price structure, and may or not be fully reflective in any series of prices. Price activity neither singles out any particular cost nor does it mirror its greater or less than rate of change within that price, and thus is random. Variable costs are a larger percentage within the component of price today, which makes the price range larger and less subject to retracement, and generally have always been greater than an initial sum-total estimate over a defined period of contracted time.

Variable costs have historically been very hard to control due to time issues related to immediate needs—any delay is greatly magnified in cost overruns. Time is a cost just as are raw materials, labor, etc.; in fact, time is a highly leveraged cost, and its effect is non-retraceable or recoverable. It is the lack of replacement product that is fundamental to time cost—it has to replace first before doing other things and that takes time and a non-random price effort while finding it. Costs are by nature more non-random than price with the variable component even more so—costs also occur much earlier than final demand. Pricing power has difficulty matching-up due to its more random nature and relationship to this future demand. Supply and demand have been distinctly laid out as the foundation for markets with an emphasis on final demand pricing.

The prices applied to these standard contracts are universal in that they convey the same message to participants as well as those on the sideline who are not involved in a particular transaction: the collective view of market users on how to measure or assess current risk within the market as a whole for the underlying referenced contract. Over the years, the risk chain associated with demand has grown dramatically in the number and magnitude of risks. The normal situation is to have a singular price-measured risk from all the elements of the risk chain (excluding those of a catastrophic nature—which are more sudden or immediate and cannot be discounted through time as can other more normal risks). It is the shifting influence between related demand risks among the various forward influences that makes price available through market access. This is called random activity. It is the basis of liquidity, which is so desirous in standard contracts.

The increased risk chain has made it very difficult to isolate reduction of market risk so that opportunity can be greater than immediate market cost. Thus, standard contracts are mostly adversarial in nature in that there is no advantage for either party at the time of the transaction; but standard contracts do represent a “zero-sum” effect over time as an advantage materializes to one of the parties. Many different types of risks are assumed upon activation of the contract, and the risks fully apply until cancellation of the contract. It is the new growing number of risks within a broader or expanding risk chain that are related to cost that are the most difficult with which to deal as they relate to supply costs rather than demand pricing. This is because they create pricing differentials that are much larger than demand pricing differentials, thus forcing a structural problem of internal imbalance upon what is supposed to be a balanced environment. The market pricing structure related to access is not designed to deal with uncertainty related to cost, so as these risks enter the marketplace, a new way of dealing with these changes has to be forthcoming.

In addition to price being the most commonly referred to differential of standard contracts, the nature of the use of price in standard contracts further reinforces its weight. Because traders typically can buy exchange-traded standard contracts on margin, price enjoys a leveraged position in the management of standard contracts. This external leverage also serves as an additional medium that assures randomness by making price changes more uncertain. In addition, price has always had a far greater magnitude in the minds of traders than the amount of the contracted commodity, because price relates directly to their ability to access or define opportunity within the standard contract, while quantity remains more of a personal decision. Still further, because there is no actual need to deliver the underlying referenced commodity at the time a standard contract is traded, supply or replacement cost has been relegated to a lesser variable than price because it is just faintly in the background. For these and other reasons, in standard contracts replacement cost has been not an element of equal weight to final demand pricing. Therefore, any change in cost status from nominal will affect markets in ways that can only be detrimental to random access. Time as a cost trumps price, that is, an immediate lack of replacement induces a shortage of supply, which creates an imbalance in what is supposed to be a balanced environment. Price change will be or will at least tend to be non-random versus its more normal random self under these circumstances depending upon how close replacement is to availability (time).

At an organic level, however, cost is the key element in any such contract because, without cost, meaningful price activity cannot take place. It is part of the foundation of price, that is, the basis for the dollar amount of price includes the assessment and summation of the markets recognition of those costs. Costs, being internal, are the true derivatives of price. Having cost in the background, as it is in standard contracts, allows the two-sided balance that comes from market rotation (e.g. prices going up and down in roughly proportional and smaller increments) to find efficiency within that pricing so that there is always availability, thereby assuring access cost neutrality within a normal pricing structure. This functioning takes place within a small range of the dollar amount of price—removing soft costs like profit margins and fixed costs like overhead etc.—the processing is limited to about 15-20% of the dollar range of prices—and not the whole range. Cost therefore offers a more direct economic base (larger part of price range) from which to start and a need exists to be able to engage this focus either directly or on a more relative basis to the existing price structure. For example, if the market is using the last 15% of the range trying to find efficiencies, and variable costs increase the base cost by 25%, the market remains in the mode of using the last 15% of the higher range for its fine tuning and little or no concern related to the new 25% range increase due to those costs being non random in nature. The effects of the weight of price in standard contracts at the expense of cost can be seen today in the fuel surcharges within the freight industry where pricing structure has advanced, and within the airline industry where these costs are in conflict with final pricing power of ticket prices.

The combinations and limitations that can take place between standard elements, namely quality, quantity, duration, delivery time, delivery location, price, and related pricing derivatives such as costs, provide more flexibility than just price alone if each element is greater or less than an ordinary fixed standard. This creative process is the means at hand that can greatly expand the industry product base, and these complex products offer an ever-increasing challenge related to efficient access. An all-inclusive price risk chain includes many independent risks: by highlighting the most dominate element in a contract—the amount of a particular cost—and allowing for a small change to potentially leverage a contract, the broad market price risks become subservient to the more activated cost. A defined economic beginning can be brought through the remaining gauntlet of risk by means of navigation rather than by a random, indirect course. Therefore, contracts that highlight cost potentially have a more direct benefit, a more created than found use, more diffusion as it relates to concentration, and thus would provide benefit to the industry by making a limited product base much larger.

Costs therefore offer an excellent foundation for a better trading basis (earlier and non-random) and can be the springboard toward a change to more of a profit than fee based industry due to offering up more than just random prices that are hard to trade. What would thus be beneficial would be the creation of a class of cost-based financial products.

### SUMMARY OF THE INVENTION

In accordance with the principles of the present invention, cost-based financial products are provided. The cost-based financial products are created at a front end that differentiates at the access level, thereby providing two distinct products—one evolving from direct arbitrage; the other an indigenous copy—that are essentially the same and are ones that can flow separately into different service entities. A fixed yield or amount of supply of a first component is divided into a variable yield of a second component that represents the cost basis relationship sought, thereby creating a partial supply devisor quotient scale—a new scale of cost unit change that becomes the new price array on the front end.

A front-end application increment ladder can be created by substituting a price per divisor supply (whether shares of stock, bushels of grain, etc.) quotient scale for the matrix price array of the cost component to accept the expanding or contracting value of the gross changes of the cost product value. Each trade price increment allows buying or selling of those differentials as they occur in the mimicked cost product ladder or the indigenous one. The new application increment ladder or price array is the same as the normal pricing increments of the supply divisor. The variable yield of the cost component will expand and or contract into this scale, thereby offering its differentials to be thusly priced, and with each trade price increment allowing access for either buying or selling that second component. The cost-based financial product of the present invention enables an indigenous marketplace where traders can make a directly offsetting trade at any of the trade prices, thereby bypassing the arbitrage base by choosing the indigenous one.

### BRIEF DESCRIPTION OF THE DRAWINGS

FIG. 1 is a non-limiting example of a trading screen for a cost-based financial product in accordance with the principles of the present invention.

FIG. 2 is another non-limiting example of a trading screen for a cost-based financial product in accordance with the principles of the present invention.

FIG. 3 is another non-limiting example of a trading screen for a cost-based financial product in accordance with the principles of the present invention.

### DETAILED DESCRIPTION OF THE INVENTION

Supply and demand have been distinctly laid out as the foundation for markets, while in the present invention supply represents an immediate replacement need or cost, and demand relates to future and final usage. Pricing of most standard products is mostly demand influenced (later), and many times this price does not reflect or even cover the earlier actual costs that went into the product—the term product used herein in its broadest all encompassing sense, such as commodities, stocks, compiled indices, etc. Supply and demand have in the past been represented as a two-stage process that always has been treated as one through the medium of a single price(s), thus the opportunity at hand. The present invention deals with this earlier risk and offers a sharp time contrast as well as complimentary ways of using it within the present trading structure that until now has been limited to an all-inclusive price.

The potential for expansion of the industry's product base is inherent when tied to costs. For instance, if the two biggest costs related to price can be isolated, and if the two biggest costs related to price move more than price, the product base expands exponentially: the original contract, two new ones, and the new relationships between all three, much the same as soybeans, soybeans meal, and soybean oil are broken out as price components versus those of costs as does the present invention. The ability to create and discard product is more expansive for the industry than just holding on to a standard product base, and the immediate past has proven it very difficult to find more standard products. A key is the ability to differentiate at the access level. Current exchange traded contracts are based upon the concept of price as the means to covey risk or provide transference while the present invention offers many derivatives of that price. The choice of accessing a cost as a price versus solely or indirectly those of an all-inclusive price will provide an ever-changing focus over time, thus allowing discarding when out of focus and thus giving or providing multiple products in accordance with the present invention that offer more distinct service opportunities.

In accordance with the principles of the present invention, cost-based financial products are provided. The cost-based financial products of the present invention are created at a front end that differentiates at the access level, thereby providing two distinct products—one evolving from direct arbitrage; the other an indigenous version—that are essentially related but can flow separately into different service entities. A fixed yield or amount of supply of a first component is divided into a variable yield of a second component that represents the cost for focus, thereby creating a partial supply devisor quotient scale to accept the pricing differentials of that focus.

As described in more detail below, a front-end application increment ladder (price array) can be created from the partial supply devisor quotient scale, which has the same normal pricing increments of the supply divisor. The variable yield of the cost component will expand and or contract into this scale, thereby offering its differentials to be thusly priced, and with each trade price increment allowing access for either buying or selling of that second component at the formulated rate.

The cost-based financial product of the present invention enables an indigenous marketplace where traders can make a directly offsetting trade at any of the trade prices on the price array, thereby bypassing the arbitrage base. This is analogous to having an external power connection to a house and at the same time installing a solar or wind system that has a variable productivity, allowing usage when favorable conditions are present therefore using less of external power, while retaining the right to use it when conditions are unfavorable. The ownership of the second system is retained not by a third party, but by the creator of the backup system.

A cost-based financial product in accordance with the principles of the present invention is created at a front end, and can and will be defined by contract specification laid out at that level. A cost-based financial product (“CBFP”) in accordance with the principles of the present invention has a fixed yield or amount of supply of a first component divided into a variable yield of a second targeted cost component, thus creating a partial supply devisor quotient scale of pricing:

$$C B F {P}_{t} = \frac{VarYieldComponent}{FixedYieldComponent} = Quotient Scale of Supply Divisor$$

This produces an increment access scale or price array that uses the same increment scale of the fixed yield component of price; thus, both the new isolated cost and the normally used portion of that price scale will be the same but trade at different levels—generally lower on the scale, which is relationship wise where one would peg them.

A cost-based financial product in accordance with the principles of the present invention defines a front-end application ladder by providing a new price array that accepts the change increments of the variable costs of the second component. Each trade price increment (developed at the front end) can buy or sell the whole of the second component—the same as direct access would otherwise be, thus providing a basis for easy and direct usage. In other words, the access ladder of the cost component is fully replicated in the new display with the effect that direct access to that product has been broadened beyond that initial base. In a transaction, only the variable second component would be traded at each incremental price. The ladder access volume (that is, the dynamic of the set up) of a cost-based financial product of the present invention would be the same as that base cost contract ladder in other venues—the difference in the setup being the new quotient scale that replaced the price array scale of that cost product. Thus, the arbitrage set up will allow access to the same base product, while the secondary or supplemental ladder would accept indigenous trades independently of the arbitrage backup.

In one implementation of a cost-based financial product in accordance with the principles of the present invention, a fixed yield of a commodity and a variable yield of a commodity are provided. Examples of such fixed yield commodities can include fuels such as crude oil, natural gas, ethanol, crude oil; bonds such as Treasury Notes, agricultural products such as corn, soybeans and wheat; equities such as stock or exchange-traded funds; financial instruments such as options and futures; precious metals such as gold; currencies such as the Dollar and the Euro; financial indexes, compiled indices, etc. Examples of such variable yield commodities also can include fuels such as crude oil, natural gas, ethanol, crude oil; bonds such as Treasury Notes, agricultural products such as corn, soybeans and wheat; equities such as stock or exchange-traded funds; financial instruments such as options and futures; precious metals such as gold; currencies such as the Dollar and the Euro; financial indexes, commodity indexes, other created indexes, etc.

The fixed yield or supply of the first commodity is divided into the variable yield of the second commodity. In a preferred embodiment, the new contract quotient increments or price array can access a whole contract quantity from the variable yield commodity, thus providing a basis for easy and direct access. Only the variable yield commodity differentials are traded at each incremental price: for instance, the variable yield commodity price would equate to a per measurement amount of the fixed yield commodity price, as the variable yield commodity prices change in relationship to the incremental formula used in the front end. The cost-based financial product's ladder access display (that is, the dynamic of the set up) would be the same as the base contract elsewhere, and in addition offer an indigenous mode as an alternative access route. Thus, the price of the variable yield commodity is converted from its normally expressed price per unit into the new structured increments of the host contract (the divisor).

Referring now to the Figures, non-limiting examples of trading screens for cost-based financial products in accordance with the principles of the present invention are seen. The Figures herein are limited to depicting the trading columns that can be utilized in any of a plethora of trading displays as know in the art. In addition, while displayed as columns the principles of the present invention apply regardless of the orientation of the data.

In trading screens in accordance with the present invention, replicated access/depth is displayed, as is the cost-product price-array of the quotient divisor. The ladder capabilities are displayed for the new access/depth columns for indigenous trades. The horizontal avenues or levels are displayed for convenient usage between access/depth and the cost-product price-array. In some cost-based products of the present invention, avenue or level adjustments for pricing accommodations are made as described in detail below. Needed price arrays can be provided that define a change in the cost matrix output, i.e., yield differences versus price differences in two-year note so that a common ground will serve to define the differential and the quotient scale enabling the desired output for display and access. In all cases, the normal price increment change of the cost product will remain whole; in all cases, the quotient scale of the divisor will retain numerical pricing control. Adjustments will be made so that the non-fitting increments of the quotient scale are matched, and this can be done by expanding the vertical scaling of the cost product to skip a line, expanding between the minimum increments of the quotient display and inserting conforming, partially conforming or non conforming prices, adding another form of pricing array, or any combination of all of the above.

Thus, in accordance with the principles of the present invention trading displays know in the art can be adjusted as follows: the replicated access/depth columns can be moved to now be available in the cost product to the new screen; the cost product price array can be replaced with the quotient divisor; the same ladder capabilities can be added to the new access/depth columns for indigenous trades that the matrix has; the horizontals avenues or levels can be coordinated for convenient usage between earlier mentioned additions; avenue or level can be adjusted for pricing accommodations—align where pricing differentials are the same, add spaces to cost ladder columns where quotient scale is smaller than minimum cost increment change, broaden the minimum range in quotient scale to accommodate smaller or non matching cost scale increments; and any needed price array that will define a change in the cost matrix output can be added, for example, yield differences versus price differences in two-year note so that a common ground will serve to define the differential and the quotient scale.

Referring again to the Figures, in one column the quotient scales of supply divisor (“QSD”) can be displayed. In another set of columns, the current bids and offers for the fixed yield or amount of supply of the first component (“FYC”) can be displayed (“bid/ask). In yet another set of columns, the current bids and offers for the cost-based financial product (“CBFP”) can be displayed (“indigenous bid/ask). Orders can be submitted by left clicking in the ‘bid’/‘offer’ column at the desired price.

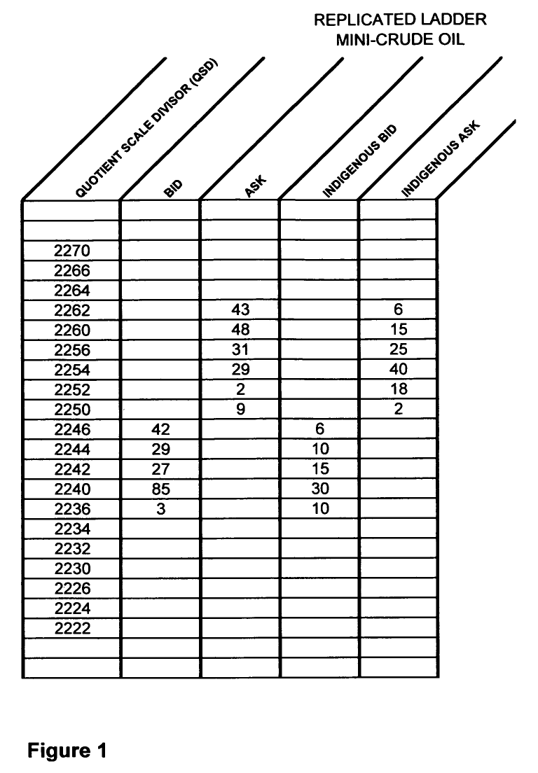

In some examples of a cost-based financial product in accordance with the present invention the conversion will be direct on a tic-for-tic basis. This situation can be seen in FIG. 1, where a trading screen for a cost plus product is displayed with the new quotient scale replacing the matrix scale of the mini-crude contract on an exact basis. In this example of a cost-based financial product in accordance with the principles of the present invention, a 100-acre contract at 200 bushels per acre or twenty thousand bushels (fixed supply) would be divided into the variable cost of a single mini-crude oil contract that represented 500 barrels of crude. The new cost contract increment would represent a crude contract valued into a lower portion of the same pricing scale (increment) related to the price of corn per bushel—that is, where corn was trading at an all-inclusive price of $5.12 a bushel, the cost portion—crude—would be trading lower on the same scale, at say $2.90 per bushel. At each increment within the established price increment series, a cost-based financial product would trade the difference in value of the cost product in accordance with the principles of the present invention. Each of those trade price increments (developed at the front end) would be buying or selling a whole mini-crude contact, thus providing a basis for easy and direct access.

In a transaction of this example, only crude would be traded at each incremental price: for instance, crude at $90 a barrel would equate to $2.25 per bushel, at $89, it would be $2.221/2—as crude prices change in the front end due to the incremental formula. The cost-based financial product's ladder access volume (that is, the dynamic of the set up) would be the same as the base contract of mini-crude in other venues; however, the increment of its change—its pricing array would shift to the pricing scale of corn due to the creation of the quotient scale that replaced the matrix scale of crude. Thus, the price of crude oil is converted into a per bushel format that is the same as corn is now traded, only it resides lower on an unused portion of that same pricing scale, which provides a related difference basis through time for the now separated contracts.

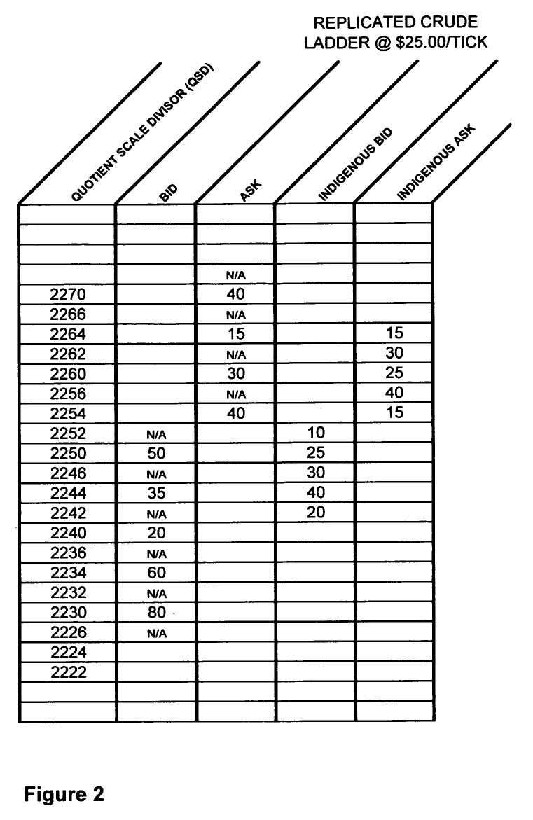

In another example of a cost-based financial product in accordance with the present invention, the minimum contract incremental change of the fixed yield or amount of supply of the first component (“FYC”) are not equal. This situation is seen in FIG. 2, where a trading screen for a hypothetical cost-plus product is displayed. In this product, the access price of the cost product is assumed to be $25.00 versus one of $12.50 for the receiving quotient scale. In this trading screen, the columns are the same as the columns of the FIG. 1 example, except that there are spacing increments in the bids and offers of the matrix access scale, which have been created by expanding the horizontal lines between the bids and offers. These spaces are non-tradable in the arbitrage portion of the display, but remain active where the indigenous bids and offers are displayed. This arrangement allows for the matrix price increment to remain whole while still allowing access to be numerically controlled by the quotient scale.

In FIG. 2, every alternating horizontal line is activated for access on the arbitrage platform, while every horizontal line would be active for access to the indigenous bid and ask (in FIG. 2, ‘N/A’ denotes not available.) Trades are not available at ‘½’ tick (which is shown by N/A); only when both the QSD tick value and the indigenous tick value is a multiple of $25.00 are trades available. Of course, indigenous trades would trade at every tick on QSD.

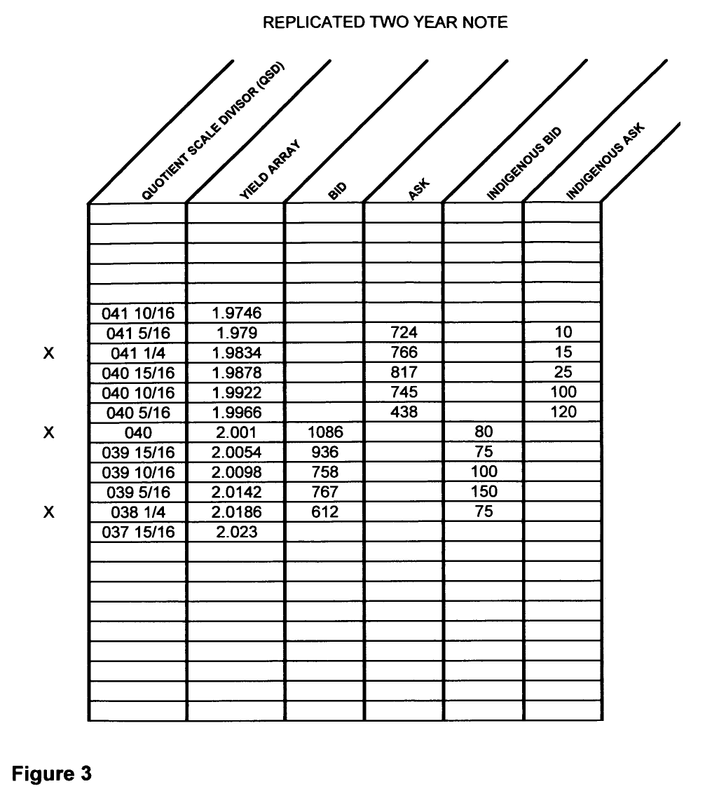

Referring now to FIG. 3, another trading screen for a cost plus product is displayed. In this example of a cost-based financial product in accordance with the principles of the present invention, a two-year note can be equated to fifty acres of $4000 per acre land—$200,000 of land represented by a $200,000 two-year note contract. The crop yield on fifty acres is ten thousand bushels—the divisor—while the yield on a two-year note is the variable—using a rate of interest at 6% on annual basis would be $12,000—divided by 10,000 or $1.20 a bushel. Given a market rate change down to 5.75%, the price per bushel would be $1.15.

Thus, the price of land on a per acre basis is converted into a per bushel of corn financial product expressed as a yield basis of interest rate change on the two year note. The price arrays on this format would be expanded to two—yield changes as per minimum cost contract change as well the quotient scale of the price per bushel of corn—so that they could be equated. Thus, the access ladder of the two-year note and its price changes would flow to yield and then to the quotient scale of the supply divisor, which in this case was a number of bushels of corn produced on 50 acres. This would represent the same access types and hold the same economic advantages as the mini-crude contract example above.

A price change increment of a two-year note in a yield basis versus a normal tic that measures it to itself through price-to-price change is displayed. It is an added array that accompanies the quotient scale divisor of corn as formulated in accordance with the present invention—50 acres of land @ $4000 per acre with a supply divisor of 10,000 bushels. The minimum tic change for the two-year note is a quarter tic that equals $15.62—corn has a minimum tic of $12.50 at a quarter tic, but by breaking it down to 16^{ths} or $3.12 per unit, change increments of 5/16^{ths} can be utilized as an internal match. The quotient array pricing scale has been adjusted to accommodate access at these new units, i.e. 5/16^{th}, and at the accumulated interval of every 20/16^{ths}, the actual tic for tic value will equate—will be financially equal, which is shown by an X just outside and to the left of that quotient scale.

The basic assumptions is the corn QSD produces a referenced quotient scale relationship of $1.20 a bushel at 6%, and the market is trading around the 2% range, which gives a QSD of $0.40 per bushel—which is the starting point on the display. The following adjustments have been made to match the tic dollars of the two-year note to the corn QSD—the QSD minimum change is moved to 5/16^{ths} or $15.60 instead of ¼ or $12.50 to accept the changes of that cost product. The $15.62 per tic change in the two-year note has been converted to a yield array that reflects and keeps that same integrity. At the 20/16^{ths} mark where the equalized financial match-up of corn and the two-year note are the same, a quarter cent increment number can be used—and then the increment base is restarted in 5/16^{ths} increment until the new set reaches 20/16^{ths}, where corn is again displayed in its natural unit of a quarter, and so on down the line of progression. In this manner numerical control of pricing remains with the quotient scale.

In reviewing the Figures, the issue is to show how pricing scheme match ups are handled versus the basis of the cost product output into the supply divisor quotient scale. The cost basis output retains its increment of change at each potential trade price of access. This output can be converted to other forms of measurement (such as yield in the two-year treasury example) as long as the integrity of the minimum differential is maintained, and numerical control resides in the quotient scale.

Where access into the cost product was in a decimal format and the host quotient scale was in a fractional format or any other non-matching format, the minimum tic of the quotient scale can be spread out to make access available between the normal minimums. Trade access would be available at these intervals and those where natural match ups occurred. The quotient scale provides a linkage to the host matrix scale even where no natural match ups occur. As described earlier, the indigenous ladder provides access at any of the created intervals established as well as those avenues providing direct access to the arbitrage set up. A key for control on the trading screen will be the horizontal lines or avenues that provide direct arbitrage access and those of a supplemental nature that provide access only to the indigenous part of the display. They run from the quotient price array through the arbitrage ladder (whether active or blank) and conclude with the indigenous one.

Thus, in all of the Figures direct arbitrage would be functional, and with this in place an indigenous marketplace could develop, one where two traders desire to make a directly offsetting trade at any of the trade prices (an indigenous trade), thus bypassing the arbitrage base. Each front-end service ladder would indicate the different access volumes (arbitrage/indigenous) at each potential trade access price and allow the indigenous bid and ask to be seen and matched separately. Thus, two independent and competing entities can be provided in the present invention. The bid/ask ladder format would equate on a horizontal scale to both the constructed variable cost contract size ladder plus the indigenous.

Where the indigenous was less liquid—creating a situation where an ask price was below the current bid in the always available arbitrage format—the present invention would automatically move the less efficient offer/bid to the same access quote available on the direct arbitrage ladder so that exposure would always be the same. The order may or may not be filled, but the choice of venues remains with the trader. Volatility would be downsized by the base divisor outcome of partial versus whole supply to be less than of the cost product, therefore making direct application much easier, thereby allowing margins and costs to be lower. For example, a one-dollar move in crude would equate to $500.00 in the mini-crude contract; the same move divided into twenty thousand bushels would be $0.025 per bushel. These particular cost contracts moved more than corn—from June 1 to December 1 corn/mini-crude had a net range of approximately $0.90 cents per bushel—while during the same timeframe the corn/two year note had one of almost $0.45 cents per bushel, and corn price itself slightly more than $0.05 cents per bushel. The price of corn did catch up later as is quite typical of demand pricing. The latter illustrates a time insensitive discovery process where the price of corn is more related to future demand than to the immediate cost of supply. As more varied or just different divisors are found for price contracts (all stocks, all commodities, all types of indices), more and more cost-based products can be created for direct application. This would expand the usage of any potential cost contract beyond the limited use of the current standard contract base.

An advantage of a cost-based financial product in accordance with the principles of the present invention is the treatment of the indigenous contracts as separate and distinct. In a cost-based financial product of the present invention, new contract ownership (versus the arbitrage where ownership is imbedded within that same process) comes directly as a result of the cost-based financial product of the present invention being put into play at a critical juncture in the well-established field of arbitrage. Instead of just a price difference that is normally associated with the arbitrage process, a cost-based financial product of the present invention establishes contract differences, a much bigger and more expanded field than the extremely limited opportunities arbitrage has allowed to date.

It should be understood that various changes and modifications preferred in to the embodiment described herein would be apparent to those skilled in the art. Such changes and modifications can be made without departing from the spirit and scope of the present invention and without demising its attendant advantages. It is therefore intended that such changes and modifications be covered by the appended claims.

What is claimed is:

1. A cost-based financial product comprising a fixed yield of a first component divided into a variable yield of a second component, thereby creating a partial supply devisor.

2. The cost-based financial product of claim 1 further wherein the variable yield component is traded at each incremental price.

3. The cost-based financial product of claim 1 further wherein cost increments are divided into a standardized, whole contract amount for the variable yield component.

4. The cost-based financial product of claim 1 further wherein the price of the variable yield component is converted into a per price measurement of the fixed yield component.

5. The cost-based financial product of claim 1 further including a front-end application ladder created by dividing into increments the variable yield component, with each trade price increment buying or selling that component.

6. The cost-based financial product of claim 5 further wherein the front-end application ladder volume and the base contract volume are the same.

7. The cost-based financial product of claim 5 further wherein the front end application ladder indicates different volumes at each trade access price and allows the indigenous bid and ask to be seen and matched separately.

8. The cost-based financial product of claim 1 further including an indigenous marketplace where traders make a directly offsetting trade at any of the trade prices, thereby eliminating the arbitrage base.

9. A cost-based financial product comprising a financial product created at a front end that differentiates at the access level, thereby providing two distinct, but rated products that can flow separately into different service entities.

10. The cost-based financial product of claim 9 further including a front-end application ladder.

11. The cost-based financial product of claim 10 further wherein the front-end application ladder is created by dividing into increments variable cost of a second component, with each trade price increment buying or selling the second component.

12. The cost-based financial product of claim 10 further wherein the front-end application ladder volume and the base contract volume are the same.

13. The cost-based financial product of claim 10 further wherein the front-end application ladder indicates different volumes at each trade access price and allows the indigenous bid and ask to be seen and matched separately.

14. The cost-based financial product of claim 9 further including a fixed yield of a first component divided into a variable yield of a second component, thereby creating a partial supply devisor.

15. The cost-based financial product of claim 14 further wherein the variable yield component is traded at each incremental price.

16. The cost-based financial product of claim 14 further wherein cost increments are divided into a standardized, whole contract amount for the variable yield component.

17. The cost-based financial product of claim 14 further wherein the price of the variable yield component is converted into a per price measurement of the fixed yield component.

18. The cost-based financial product of claim 9 further including an indigenous marketplace where traders can make a directly offsetting trade at any of the trade prices, thereby eliminating the arbitrage base.

19. A display for trading cost-based financial products comprising:
a first column displaying a quotient scale of supply divisor;
a second column displaying bids for a fixed yield of a first component;
a third column displaying offers for the fixed yield of the first component;
a forth column displaying bids for the cost-based financial product; and
a fifth column displaying offers for the cost-based financial product.

20. The display for trading cost-based financial products of claim 19 further wherein orders can be submitted by clicking in the ‘bid’/‘offer’ column at the desired price.

21. The display for trading cost-based financial products of claim 19 further wherein the placement of the second column and the forth column are adjacent.

22. The display for trading cost-based financial products of claim 19 further wherein the placement of the second column and the third column are adjacent and the forth column and the fifth column are adjacent.

23. The display for trading cost-based financial products of claim 19 further wherein the quotient scale of supply divisor is;

24. The display for trading cost-based financial products of claim 19 further wherein the variable yield component is traded at each incremental price.

25. The display for trading cost-based financial products of claim 19 further wherein cost increments are divided into a standardized, whole contract amount for the variable yield component.

26. The display for trading cost-based financial products of claim 19 further wherein the price of the variable yield component is converted into a per price measurement of the fixed yield component.

27. The display for trading cost-based financial products of claim 19 further wherein the quotient scale of supply divisor is determined by the fixed yield of the first component being divided into a variable yield of a second component.
